(19) United States
(12) Patent Application Publication
(10) Pub. No.: US 2006/0201338 A1
(43) Pub. Date: Sep. 14, 2006

(54) Accessory for a conventional automatic bread toaster

(76) Inventor: Melvin L. Levinson, Edison, NJ (US)

Correspondence Address: MELVIN L. LEVINSON, 8 STRATFORD CIRCLE, EDISON, NJ, 08820-1830, US

(21) Appl. No.: 11/075,517

(22) Filed: Mar. 10, 2005

(51) Int. Cl. A23L 3/32

(52) U.S. Cl. 99/451

(57) ABSTRACT

At least one removable accessory foodstuff holder is inserted into one slot of a conventional automatic toaster. When in place the foodstuff holder shields one side of a foodstuff from direct exposure to infrared radiation from one of the toaster slot's two opposing heating element and exposes the other side of said foodstuff to the direct infrared radiation emitted from second heating element of the toaster. The side, shielded from direct infrared radiation of said foodstuff, is heated by heat conducted to it from the shielded toasting element. A heat insulating means is provided to facilitate the insertion and removal of said foodstuff holder. The holder is useful for the toasting and heating of bagels, rolls, bread, pretzels, waffles and similar foodstuffs fabricated for conventional toasters.

### CROSS REFERENCE TO RELATED APPLICATION

Not applicable

### BACKGROUND OF THE INVENTION

1. Field of the Invention

This invention concerns a removable, metal, accessory, food holder designed to be inserted into one of the bread openings of a conventional, automatic, pop-up, bread toaster.

2. Discussion of the Prior Art

Initially bread was toasted held over an open fire. Later bread was toasted on a stove resting on a metal apparatus over a gas flame. With the advent of electricity, one side of a slice of bread was exposed to an electric element. A later improvement permitted the operator to toast both sides by mechanically reversing the slice of bread. Then, to simultaneously toast both sides of a slice of bread, the slice of bread was placed between two electric elements. Then the multi slice toaster and the automatic pop-up toaster were invented.

It is well known to toast the foodstuffs taught in this invention under the broiling element of a conventional kitchen oven and under the broiling element of a conventional toaster oven. It is well known that a conventional automatic toaster have independent utility over a conventional kitchen oven and a conventional toaster oven because, by design, a toaster positions a foodstuff closer to its dual infrared elements in contrast to the infrared elements of a conventional kitchen oven or the infrared elements of a conventional toaster oven.

### BRIEF SUMMARY OF THE INVENTION

At least one removable, accessory, metal, foodstuff holder is inserted into a slot of a conventional automatic toaster. When in place it shields one side of a held foodstuff from direct infrared radiation from one of the two electric elements present in a conventional automatic toaster's slot. In operation, the side of said foodstuff, shielded from direct radiation by the foodstuff holder, is heated by heat conducted to it through the foodstuff holder when, in operation, the foodstuff holder is heated by the shielded toasting element. In operation, the foodstuff holder permits the normal toasting of only one side of a foodstuff held in the foodstuff holder. A heat insulating means is provided to facilitate the insertion and removal of said foodstuff holder.

It is an object of this invention to add to the utility of conventional automatic toasters by providing a simultaneous one side toasting and a reverse side conduction heating and/or defrosting of foodstuff toasted in an automatic toasters.

It is an object of this invention to toast in a conventional automatic toaster just the crust side of small, medium or large store-bought, frozen, convenience bagels.

It is another object of this invention to provide removable means to toast in a conventional automatic toaster just the crust side of miniature, store-bought, frozen, convenience bagels and rolls.

It is an object of this invention to provide heat insulating means to easily and safely remove from a conventional automatic toaster a small, hot toasted foodstuff and transport it to the table.

It is an object of this invention to increase the utility of conventional automatic toasters by providing an accessory foodstuff holder that, when inserted into a toaster, in operation, results in a simultaneous one sided toasting and a second side heating and/or defrosting of bagels, rolls, bread, pretzels, waffles and other foodstuffs designed to be toasted in a conventional toaster.

### DESCRIPTION OF THE DRAWINGS

The advantages and benefits resulting from the described accessory foodstuff holder will become apparent from the following detailed description and by reference to the accompanying drawings in which:

FIG. 1 is a front view of the accessory foodstuff holder holding a slice of bread.

FIG. 2 is a side view cross-section of FIG. 1.

FIG. 3 is a side view of a conventional automatic toaster.

FIG. 4 is a top view of the conventional automatic toaster of FIG. 3 with a top view of FIG. 1 in one of its toaster slots.

### DETAILED DESCRIPTION OF THE INVENTION

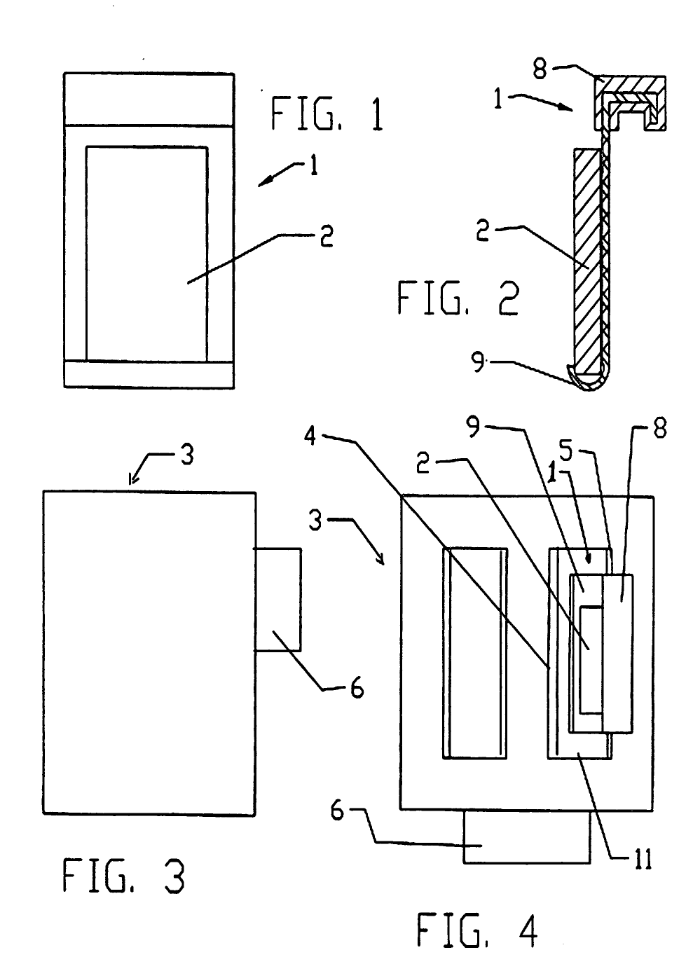

In FIGS. 1 and 2, a novel accessory foodstuff holder 1 is illustrated for use in a conventional automatic toaster 3. A slice of bread 2 is illustrated in place in accessory foodstuff metal holder 1's foodstuff support 9. A heat insulating means 8 encases accessory foodstuff holder 1's handle 10.

Preferably accessory foodstuff holder 1 is aluminum, but other heat conductive metals, such as stainless steel, designed to contact a foodstuff are acceptable. Heat insulating means 8 preferably is a high temperature plastic as silicone rubber.

In FIGS. 3 and 4, a foodstuff designed to be toasted in a conventional toaster, is placed in foodstuff support 9, and the assembly is inserted into slot 11 of conventional automatic toaster 3. Conventional automatic toaster 3's energizing lever 6 is engaged and the assembly drops down into slot 11. In operation, when foodstuff holder 1 is in place in slot 11 the side of the foodstuff 2 exposed to electric heating element 4 toasts. Simultaneously the side of foodstuff 2 that contacts foodstuff holder 1 is heated and/or defrosted by heat conducted through foodstuff holder 1 from toasting element 5. Note the side of foodstuff 2 that contacts foodstuff holder 1 is shielded from direct radiation from electric toasting element 5. After a predetermined amount of toasting, the energizing lever 6 pops-up, the operator, utilizing heat insulating means 8, removes the toasted foodstuff, held in accessory foodstuff metal holder 1, from conventional automatic toaster 3. If the foodstuff, for example a dough-encased, prefrozen, convenience, breakfast treat, is too hot to touch, accessory foodstuff metal holder 1 can additionally be employed, as a serving piece, to transport hot toasted foodstuff to the breakfast table.

One example of how, in operation, two accessory foodstuff metal holders are employed is first a prefrozen bagel is cut in half exposing a crust side and a dough side. Then, each bagel half is placed individually in the two accessory foodstuff metal holders. The two accessory foodstuff metal holders, each holding a bagel half, are inserted individually into the slots of a conventional automatic toaster with their handles pointing outward. Preferably the bagels slices are oriented so that the crust side of the bagel faces the exposed electric heating element and is toasted. The dough side of the bagel in contact with the metal surface of the accessory foodstuff holder is heated by conduction and advantageously the dough side, because it is physically in contact with the metal surface is shielded from undesirably drying out. Besides bagels, other foodstuffs, fabricated for conventional toasters, as small and large roll halves, donuts, bread slices, pretzels, and waffles, provide novel tasty results. Foodstuff holder 1 provides a useful way to toast one side of each half of miniature bagel. Foodstuff holder 1 provides a convenient and safe way to toast, remove and serve miniature bagels and rolls.

Another example of the operation of foodstuff holder 1 is to wet one or both sides of the exterior surfaces of the foodstuff prior to the selected toasting of the foodstuff in holder 1. The novel toasted results taught, herein, differ from a toasting, without foodstuff holder 1, performed either under the electric element of a conventional kitchen oven or under the electric element of a conventional toaster oven. The time and the amount of energy necessarily and the final taste and texture differ in said three toasting methods. For example, the final taste and texture of a frozen convenience bagel, toasted as taught herein, duplicates the taste and texture of a just baked bagel.

Although this invention has been described with a certain degree of particularity, it is understood that the present disclosure has been made by way of example and that numerous changes in details of construction and arrangement of parts may be resorted to without departing from the spirit and scope of the invention.

I claim:

1. For use in a conventional automatic toaster, a removable foodstuff holder that consists of:
a heat conductive foodstuff holder,
means to retain a foodstuff in said foodstuff holder when said holder is inserted into an operating chamber of said toaster,
wherein, when in the operating chamber of said toaster, said foodstuff holder shields one side of said foodstuff from the direct infrared radiation emitted from one of said toasters toasting elements and exposes the other side of said foodstuff to the direct infrared radiation emitted from the opposing toasting element of the toaster.

2. A holder, according to claim 1, wherein the heat conductive material is aluminum.

3. A holder, according to claim 1, wherein a heat insulating material is attached to the upper surface of said holder to aid in the insertion and removal of said holder from said toaster.

4. A holder, according to claim 3, wherein the heat insulating material is a high temperature plastic.

5. A holder, according to claim 4, wherein the plastic is silicone rubber.

6. A holder, according to claim 3, wherein, the holder is fabricated to transport a hot toasted foodstuff.

7. A holder, according to claim 1, wherein the foodstuff is selected from the group consisting of bagels, rolls, bread, pretzels and waffles.
